(19) United States
(12) Patent Application Publication
(10) Pub. No.: US 2026/0099381 A1
(43) Pub. Date: Apr. 9, 2026

(54) COMPILED WORKFLOW CODE FOR DISTRIBUTED COMPUTE ENGINE

(71) Applicant: Haevek Inc., Gainesville, VA (US)

(72) Inventors: Andrew R. M. Hoeft, Gainesville, VA (US); Jonathon W. Arbaugh, Philadelphia, PA (US); Kevin M. Eveker, Moneta, VA (US)

(21) Appl. No.: 19/322,524

(22) Filed: Sep. 8, 2025

Related U.S. Application Data
(60) Provisional application No. 63/704,689, filed on Oct. 8, 2024.
(60) Provisional application No. 63/794,227, filed on Apr. 24, 2025.

(51) Int. Cl. G06F 9/50; G06F 8/41; G06F 8/54

(52) U.S. Cl. CPC G06F 9/5077; G06F 8/433; G06F 8/54

(57) ABSTRACT

A distributed compute engine executes packages of compiled workflow source code that include statically linked instructions for interfacing with the distributed compute engine. The engine stores a compute engine library of computer-executable code and receives workflow source code from a user device, including a primary set of instructions for workflow logic and an interfacing set of instructions for calling library functions. A compiler analyzes the source code, identifies required functions and dependencies from the compute engine library, and generates compiled workflow code by statically linking referenced library code. The engine packages the compiled workflow code as a containerized workload containing application code, configuration files, environment variables, and library dependencies, and delivers it to executor nodes. The engine accesses and partitions data, assigns stages and partitions to executors, and coordinates execution.

### CROSS-REFERENCE TO RELATED APPLICATIONS

This application claims the benefit of U.S. Provisional Pat. App. No. 63/704,689, filed Oct. 8, 2024, and U.S. Provisional Pat. App. No. 63/794,227, filed Apr. 24, 2025, each of which are incorporated by reference.

### BACKGROUND

Distributed compute engines execute workflows by dividing computational tasks across multiple computing nodes, enabling large-scale parallel data processing. Users may submit different types of source code to be run as workflows within these systems. The workflow source code may be containerized and distributed to executor nodes, allowing for flexible deployment and execution. In many implementations, the workflow code is written in interpreted languages, which requires executor nodes to interpret the source code into machine code at runtime. Some distributed compute engines support compiled languages, but these systems are generally configured for specific purposes, not for general-purpose workflows.

Distributed compute engines also provide function libraries to facilitate interaction between the user's workflow source code and the engine's runtime and scheduling system. For example, these libraries may include functions for workflow stage designation, data partition management, transmitting data between nodes, executing transformations, or handling analytics routines. Typically, these libraries are dynamically linked to the executed source code. Dynamic linking refers to resolving library function addresses and loading external code dependencies at runtime rather than including them in the executable at compile time.

Dynamic linking offers benefits, such as reducing the size of compiled code packages and allowing updates or changes to libraries without recompiling workflows. However, dynamically linked functions are often slower to execute since they are not directly incorporated into the compiled code and require additional lookups and loading operations at runtime. These inefficiencies can result in increased computational resource consumption, leading to higher operating costs and reduced performance for distributed compute engines.

### SUMMARY

A distributed compute engine executes packages of compiled workflow source code that includes statically-linked instructions for interfacing with the distributed compute engine. For example, a distributed compute engine may store a compute engine library of computer-executable code, which provides functions that may be invoked by workflow source code to interface with the distributed compute engine. The distributed compute engine receives workflow source code from a user device, the workflow source code including a primary set of instructions for workflow logic and an interfacing set of instructions for calling library functions. The source code is typically written in a compiled language and may designate workflow stages and data partition management.

The distributed compute engine applies a compiler to the received workflow source code, generating compiled workflow code. The compiler analyzes the source code, identifies all required functions and dependencies from the compute engine library, and incorporates those library components as needed into the compiled workflow package. The system may use static linking to embed referenced library code directly, or dynamic linking for runtime access, with the objective of reducing unnecessary code inclusion and improving performance. The resulting compiled workflow code is packaged and delivered to executor nodes, for example, as a containerized workload containing application code, configuration files, environment variables, logging parameters, resource allocation details, and library dependencies (e.g., from the compute engine library or from other libraries).

Input data for the workflow is accessed, which may include structured tables, semi-structured files, unstructured documents, time-series data, images, video, or other formats. The distributed compute engine partitions input data into subsets for parallel execution, assigning partitions either directly to executor nodes or making them available for retrieval as needed. For each stage, the distributed compute engine selects an executor and transmits instructions with a stage identifier and partition assignment. Executors process assigned workflow stages, retrieve necessary data, and generate intermediate or final output results. Executors transmit intermediate or final output results to a designated storage location, notify the scheduler of stage completion, and update execution metadata. The scheduler revises the execution plan and triggers subsequent workflow stages, allowing for continuous workflow progress until all workflow stages are complete for all data partitions. Final outputs and execution status are recorded and made available for downstream consumption or user access.

The distributed compute engine can take advantage of the performance benefits of a compiled language for the workflow source code while also allowing for general-purpose workflows. Additionally by statically linking required functions from the reference library during compilation, the distributed compute engine reduces the overhead associated with runtime interpretation and dynamic dependency resolution. This approach reduces execution latency and improves resource utilization, as executors do not need to repeatedly resolve external library calls or interpret source code. The invention further streamlines deployment by enabling each executor node to receive a complete, optimized containerized package, ensuring consistent performance and minimizing redundant compilation efforts. As a result, the distributed compute engine enables more efficient workflow execution, lowers computational resource requirements, and enhances overall system scalability.

### BRIEF DESCRIPTION OF THE DRAWINGS

FIG. 1 illustrates an example system environment and architecture for a distributed compute engine, in accordance with one or more embodiments.

FIG. 2 is a flowchart for a method of executing compiled workflow code within a distributed compute engine, in accordance with some embodiments.

FIG. 3 illustrates the distributed compute engine receiving workflow source code from a user device, in accordance with some embodiments.

FIG. 4 illustrates the distributed compute system receiving input data from a user device, in accordance with some embodiments.

FIG. 5 illustrates the distributed compute engine transmitting instructions to executors, in accordance with some embodiments.

FIG. 6 illustrates the distributed compute engine generating and receiving execution results from executors, in accordance with some embodiments.

### DETAILED DESCRIPTION

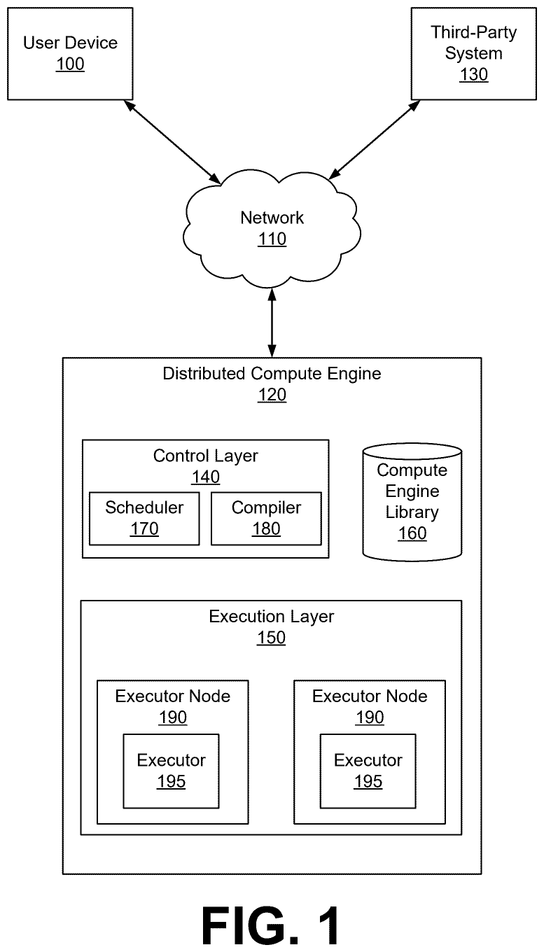

FIG. 1 illustrates an example system environment and architecture for a distributed compute engine 120, in accordance with one or more embodiments. The system environment illustrated in FIG. 1 includes a client device 100, a network 110, a distributed compute engine 120, and a third-party system 130. Alternative embodiments may include more, fewer, or different components from those illustrated in FIG. 1, and the functionality of each component may be divided between the components differently from the description below. For example, alternative embodiments may include more than one client device 100 that communicate with the distributed compute engine 120 or functionality described as being performed by distributed compute engine 120 may be performed by the user device 100 or the third-party system 130. Additionally, each component may perform their respective functionalities in response to a request from a human, or automatically without human intervention.

A user device 100 is a computing system capable of interfacing with a distributed compute engine. For example, the user device may be a laptop, desktop computer, server, mobile device, thin client, or an application programming interface (API) endpoint. The user device may allow a user to write, edit, or test source code for execution by the distributed compute engine. Similarly, the user device may be part of a broader system that interfaces with the distributed compute engine to programmatically execute workflows. For example, an enterprise automation server may allow a user to remotely write, edit, or test source code for execution by the distributed compute engine and may implement an orchestration module which utilizes an API endpoint to submit workflow definitions and trigger execution within the distributed compute engine.

The user device is further operable to upload workflow definitions, specify associated compilation parameters, define runtime configuration options, and identify sources of input data. In various embodiments, the user device is configured to receive returned output data, execution logs, error reports, and performance metrics generated by the distributed compute engine after processing. In various embodiments, one or more user devices may access an intermediate enterprise automation server which is configured to receive returned output data, execution logs, error reports, and performance metrics generated by the distributed compute engine after processing. The user device and the distributed compute engine communicate via the network, which may, in certain implementations, utilize secure protocols such as HTTPS or gRPC to ensure confidentiality and integrity of transmitted information.

The user device 100, the distributed compute engine 120, and the third-party system 130 can communicate with each other via the network 110. The network 110 is a collection of computing devices that communicate via wired or wireless connections. The network 110 may include one or more local area networks (LANs) or one or more wide area networks (WANs). The network 110, as referred to herein, is an inclusive term that may refer to any or all of the standard layers used to describe a physical or virtual network, such as the physical layer, the data link layer, the network layer, the transport layer, the session layer, the presentation layer, and the application layer. The network 110 may include physical media for communicating data from one computing device to another computing device, such as multiprotocol label switching (MPLS) lines, copper or fiber optic cables, cellular connections (e.g., 3G, 4G, or 5G spectra), or satellites. The network 110 also may use networking protocols, such as TCP/IP, HTTP, SSH, SMS, FTP, gRPC, or WebSockets, to transmit data between computing devices. In some embodiments, the network 110 may include Bluetooth or near-field communication (NFC) technologies or protocols for local communications between computing devices. The network 110 may transmit encrypted or unencrypted data.

A distributed compute engine 120 is a distributed processing system for executing workflows. The distributed compute engine may execute these workflows by dividing computational tasks into multiple stages and performing those stages in parallel across multiple nodes. The distributed compute engine uses a cluster of computing systems to execute workflows. Such a cluster may be deployed on-premises within an organization's own facilities, in a cloud environment offered by the third-party system 130, on co-located or distributed edge hardware, or any combination of these.

The distributed compute engine includes a control layer 140, which is a virtual or physical subsystem within the distributed compute engine that manages workflow compilation, scheduling, job distribution to execution resources, and resource lifecycle operations. The control layer receives workflow source code submitted from a user device and initiates further analysis, compilation, and planning for execution. The control layer may maintain data describing workflow stages, data partitions, system health indicators, and performance characteristics. In typical embodiments, the control layer is configured using one or more supervisory or master nodes within the cluster that instruct other nodes within the cluster. Alternatively, the control layer may use distributed peer nodes or a federated set of controllers across different administrative domains.

The control layer also may perform other functionalities as well for the distributed compute engine. For example, the control layer may include, or interface with, a distributed storage system such as HDFS, Amazon S3, or an object store for storing input data, intermediate data, and final output data. Such storage systems may be integrated as part of the distributed compute engine or may be operated as third-party services (e.g., third-party system 130). Furthermore, the control layer may further include: a job tracker or metadata store that maintains workflow states and execution statuses, maps workflow stages to data partitions, records executor assignments, and stores historical execution logs; a resource manager for allocating computational resources, memory, and network bandwidth across execution layer nodes according to workload requirements and configuration parameters; monitoring and logging services for tracking the status of the cluster, recording execution statistics, and diagnosing errors or performance issues encountered during workflow execution; or a security module for enforcing authentication, authorization, and encryption policies applicable to data transmissions and stored data within the system.

The control layer includes a scheduler 170, which is a subsystem that assigns workflow stages to specific executors and determines the input or intermediate data partitions on which those stages should operate. In some embodiments, the scheduler transmits containerized packages to executor nodes to cause the executor nodes to run a corresponding executor process. The scheduler also may transmit stage identifiers, configuration parameters, and partition assignments to executors to cause the executors to perform assigned tasks. Scheduler decisions may be based on a range of factors, such as current resource availability, data locality to minimize transfer times, workload balancing strategies to optimize system throughput, execution deadlines to meet timing requirements, or stage priority levels to address urgent tasks first. The scheduler may dynamically reassign tasks in response to various conditions, including execution failures, node unavailability, or detected performance slowdowns, thereby maintaining operational efficiency and workflow progress. In some embodiments, the scheduler may implement advanced modes, such as deadline-aware scheduling to meet specific time constraints, adaptive rescheduling to respond to changing system conditions, and predictive prefetching to proactively retrieve data needed for upcoming stages.

The control layer also includes a compiler 180, which is a subsystem configured to receive workflow source code from the user device and generate compiled workflow code suitable for execution on distributed nodes. The compiler may detect the programming language of received workflow source code and selects a suitable compilation process to transform the source instructions into executable code. The output of the compiler is preferably a self-contained compiled workflow package, which may be distributed to execution nodes as part of a container image containing all required runtime dependencies. The compiler also may analyze the submitted source code to identify function calls into the compute engine library and incorporates those portions of the library necessary for the workflow. In some embodiments, the compiler statically links instructions from the compute engine library 160 into the compiled code.

The distributed compute engine includes an execution layer 150, which is a virtual or physical subsystem performing executing workflows. The execution layer includes a plurality of execution nodes 190, with each node capable of running one or more executor processes 195 that perform specific workflow stages as instructed. The execution layer is further configured to retrieve or receive input and intermediate data partitions, execute the compiled workflow code corresponding to the workflow stages, and generate intermediate or final results based on the processing performed. Each execution node may communicate with the control layer, receiving task assignments, reporting execution results, and providing status updates related to workflow progress and system health.

The execution nodes 190 are physical or virtual machines configured to host one or more executors that are responsible for executing workflow stages. Each execution node receives the compiled workflow code package from the control layer, with the package in some embodiments provided as a containerized workload that contains the required application code and dependencies. Execution nodes may store assigned data partitions locally, thereby minimizing network transfer times and improving processing efficiency during execution. These nodes provide the runtime environment for executors, actively monitor execution progress, and transmit execution results and status updates to the scheduler. Execution nodes also may cache intermediate results from prior workflow stages to facilitate faster processing in subsequent stages.

Executors 195 are runtime processes that execute designated portions of compiled workflow code on one or more assigned data partitions. Executors are commonly isolated within containers or lightweight runtime environments, providing portability and reproducibility across different computing node environments. Each executor retrieves its input or intermediate data partitions from local in-memory or persistent storage, from other nodes, or from distributed storage systems, executes the specified stage logic, and generates result data. Executors may generate both intermediate results intended for further workflow stages and final results meant for user consumption. Upon completion of execution of a task (e.g., a stage applied to a partition of data), executors communicate their completion status and the location of output data to the scheduler or job tracking system.

The compute engine library 160 is a set of executable functions, application programming interfaces (APIs), or interfaces that enable workflow source code to interact with the distributed compute engine. The library may include a core library that workflow source code may use for essential functions such as designating workflow stages, managing data partitions, and supporting data transmission operations. The compute engine library also may include an advanced library that provides higher-level functionality for interfacing with the distributed compute engine, such as distributed optimization routines, specialized analytics, machine learning model integration, or high-performance data transformation algorithms. The compute engine library may be stored locally on control layer nodes, maintained in a shared repository for remote access, or kept in distributed storage that is accessible by the control layer or the execution layer. Components within the library may be designed for static linking into compiled workflow packages or for dynamic linking during runtime, depending on system requirements and execution scenarios.

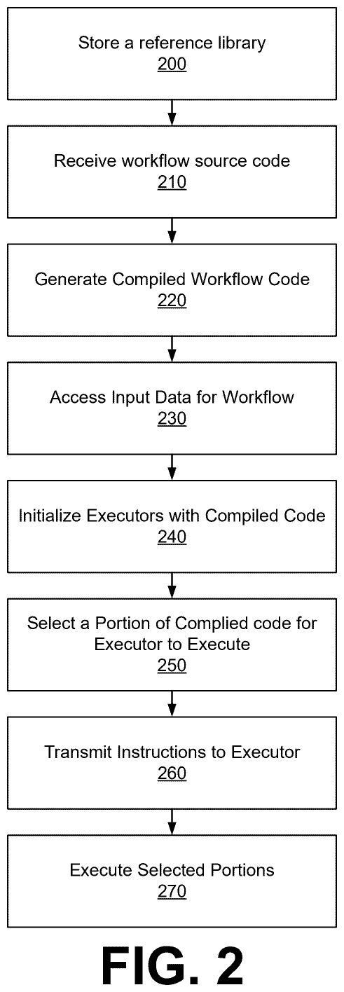

FIG. 2 is a flowchart for a method of executing compiled workflow code within a distributed compute engine, in accordance with some embodiments. Alternative embodiments may include more, fewer, or different steps from those illustrated in FIG. 2, and the steps may be performed in a different order from that illustrated in FIG. 2. These steps may be performed by a distributed compute engine (e.g., distributed compute engine 120). Additionally, each of these steps may be performed automatically by the distributed compute engine without human intervention. Furthermore, while FIG. 2 may primarily describe the use of input data, similar steps may be performed with intermediary data generated by a stage of the workflow.

The distributed compute engine stores 200 a compute engine library of computer-executable code. The compute engine library is a set of executable code that may be invoked by workflow source code to interface with the distributed compute engine. This compute engine library may provide functions that allow workflow source code to designate where the code should be divided into distinct workflow stages, as well as functions for data operations such as sorting, joining, filtering, and aggregating datasets. The compute engine library may further include APIs and pre-written routines that facilitate management and manipulation of workflow and data structures. The library may be stored locally or in a third-party system.

The system may store multiple libraries that workflow source code can reference. For example, a core library may include stage designation functions, data partition assignment routines, and primitives for transmitting data between nodes. Another library may provide advanced interfacing options, such as distributed optimization routines, calling machine learning models, specialized transformation algorithms, or custom analytics functions. These advanced libraries may use functions from the core library to support their extended capabilities.

The distributed compute engine receives 210 workflow source code from a user device. Workflow source code is a set of instructions for execution as part of a workflow on the distributed compute engine. The workflow source code includes source code, which is human-readable textual instructions written in a programming language, which define the logic and operations of the workflow. Generally, the workflow source code is written in a compiled language. A compiled language is a programming language in which source code is translated by a compiler into executable machine code prior to execution. In contrast, an interpreted language relies on an interpreter to read and execute instructions directly at runtime, often resulting in slower performance and less opportunity for optimization. With compiled languages, the compilation process generally produces a self-contained program that can run independently and typically offers improved execution speed, resource efficiency, and deployment flexibility compared to interpreted languages.

Workflow source code generally includes two sets of instructions: the primary set of instructions and the interfacing set of instructions. The primary set of instructions defines the substantive logic and operations of the workflow. These instructions specify the algorithm, computation, and decision-making steps that transform the input data into the desired output. The primary instructions may explicitly designate individual workflow stages and the corresponding operations performed within each stage. For example, the primary set of instructions may specify that Stage 1 ingests and parses raw data, Stage 2 applies transformations or filters the parsed data, and Stage 3 aggregates the transformed data and outputs results.

The interfacing set of instructions are instructions to use code from the compute engine library to interact with the distributed compute engine. These instructions enable the execution of the primary instructions within the distributed compute engine. For instance, the interfacing instructions may include function calls to routines from the compute engine library, allowing the workflow to schedule tasks, assign data partitions, or manage stage execution. The interfacing instructions may further indicate which primary instructions correspond to each workflow stage. For example, the interfacing set of instructions may include function calls that specify boundaries between stages and direct the distributed compute engine regarding task allocation and sequencing. The interfacing set of instructions also may include instructions for resource configuration, data transfer, or error handling, ensuring efficient operation and integration within the platform.

The distributed compute engine generates 220 compiled workflow code by applying a compiler to the received workflow source code. As described above, the compiler transforms human-readable instructions into executable machine code suitable for distributed execution. The compilation process may include parsing the workflow source code, analyzing its structure, identifying all required functions and dependencies, and translating the instructions into machine code that the distributed compute engine nodes can execute. The distributed compute engine may select a compiler based on the programming language of the workflow source code, with support for multiple compilers if necessary. In some embodiments, the received workflow source code includes compilation parameters and the distributed compute engine may use these parameters to create or tailor the executable form of the workload (e.g., for a target architecture).

When compiling, the distributed compute engine generally includes only those portions of the compute engine library specified by the interfacing set of instructions in the compiled workflow package. For example, the compiler may statically link functions from the compute engine library, which means the compiler incorporates their executable code directly into the compiled package, instead of loading them dynamically at runtime. Static linking ensures that the compiled workflow package contains all required code for execution, simplifies deployment, and can improve performance because the executors do not need to resolve external dependencies during runtime. By including only the necessary library components, the distributed compute engine reduces the size of the compiled workflow package and streamlines execution across distributed nodes.

The distributed compute engine accesses 230 input data for the workflow. The input data for a workflow is the data on which the distributed compute engine should execute the workflow. The input data may include structured data such as relational database tables, CSV files, and spreadsheets; semi-structured data formats including JSON, XML, Parquet, and log files; or unstructured data such as plain text documents, images, audio, or video files. In some embodiments, the input data includes sensor readings, time-series entries, geospatial coordinates, or simulation outputs. In the context of machine learning workflows, input data may include labeled training sets, feature vectors, or pre-trained model parameters.

The distributed compute engine may receive input data from a user device. For example, the user device may directly transmit the input data to the distributed compute engine for storage and use in executing the workflow. Alternatively, the user device may provide locator information to the distributed compute engine and the distributed compute engine may use the locator information to retrieve the input data from a third-party system.

The distributed compute engine initializes 240 executors on execution nodes to execute the workflow. The distributed compute engine distributes the compiled workflow code to a set of executor nodes that were selected (e.g., by the control layer) to execute the executor processes. Each executor node receives the compiled workflow code, often in the form of a containerized package. The containerized package may include the compiled workflow code, configuration files, environment variables, logging parameters, and resource allocation details. The container may also include libraries or data that the compiled workflow code references as dependencies. These libraries can be either compiled code, which is executed directly, or uncompiled (e.g., interpreted) code that is invoked at runtime when the workflow executes.

In preferred embodiments, every executor node receives the complete compiled workflow code within the container, enabling each node to execute any assigned stage of the workflow. In alternative embodiments, the distributed compute engine may distribute different portions of the compiled workflow code to specific nodes, depending on task assignment or resource optimization strategies.

The distributed compute engine may partition input data into subsets, referred to as partitions, to enable parallel execution across multiple executors. The input data is data provided by the user device on which the workflow should be executed. For example, the input data may include structured tables, unstructured text files, sensor readings, log entries, images, or serialized objects used for analytics or transformation. The distributed compute engine may receive the input data directly from the user device or the user data may provide locator information that the distributed compute engine uses to retrieve the input data (e.g., from a third-party system).

The distributed compute engine may partition the input data by dividing a tabular dataset by rows, with each partition containing a separate subset of records. The distributed compute system also may split a large file into fixed-size blocks based on data offsets. In another scenario, the distributed compute engine may partition data by user, time interval, or other logical key, allowing workflow stages to process independent portions of the input concurrently. In some embodiments, the input data is pre-partitioned and the distributed compute engine uses metadata in the input data to identify partitions in the input data.

The distributed compute engine transmits input data partitions to executor nodes for storage. In some cases, the distributed compute engine assigns partitions directly to executor nodes that will process them, based on task scheduling or resource availability. Alternatively, the distributed compute engine may store partitions on nodes that are not immediately assigned to execute the corresponding workflow stage; when needed, executor nodes request and retrieve the specific partitions for their assigned tasks.

The distributed compute engine selects 240 a portion of the compiled workflow code for an executor to execute. For example, for each workflow stage, the distributed compute engine may select which executor or executor node will perform the assigned task. The distributed compute engine may select executors based on current resource availability, proximity to relevant data partitions, historical node performance, or system policies for balancing workload distribution. In some cases, the distributed compute engine may assign stages to executors that have previously processed related data, or may prioritize idle nodes or nodes with optimal hardware configurations.

To initiate execution, the distributed compute engine transmits 250 instructions to an executor that instruct the executor to execute a portion of the compiled workflow code. For example, these instructions include an identifier for the workflow stage to execute—often a stage ID—along with any optional configuration parameters or environment variables needed for the task. The scheduler also specifies which partition of input data the executor should process, typically by transmitting a partition identifier. By providing stage-specific and partition-specific assignment details, the distributed compute engine ensures accurate execution and coordinated progress across the distributed environment.

Executors of the distributed compute engine execute 260 selected portions (e.g., stages) of the compiled workflow code based on received instructions. For example, an executor may use an identifier in the received instructions to identify which portion of the compiled workflow code to execute. The executor locates the designated compiled code block within its stored workflow package and prepares to launch the associated workflow stage. The executor determines whether it has the required input data partition available in its local storage. If the input data partition is not present locally, the executor may request it from another executor node or storage location where the partition is stored.

The executor runs the specified workflow stage, processing the input data and generating the corresponding results. The result data may be an intermediate dataset intended for processing in subsequent workflow stages, or a final output dataset for delivery to the user or external system. Intermediate data may remain partitioned in a format that supports efficient downstream operations. For example, the executor may save each processed data partition as a distinct file in a distributed file system, with naming conventions or metadata that indicate stage and partition identifiers for easy retrieval in the next workflow step.

The executor may transmit the generated output dataset or intermediate result dataset to a designated storage location or node. These storage destinations may include a distributed file system, a cloud-based object store, or in-memory storage accessible to other components in the distributed compute engine. The scheduler or the workflow logic may determine the specific storage location, assigning output paths or destination nodes in advance or dynamically as the workflow progresses.

The executor may notify the scheduler that the assigned stage and partition are complete. The notification may include an identifier for the partition processed, an identifier for the stage executed, execution time and performance metrics, and the location where the generated data is stored. The scheduler may revise the execution plan to indicate that output data for that partition and stage is now available. The scheduler also may trigger subsequent workflow stages to operate on the newly completed partition and may reassign remaining data partitions of future stages to available executors. If the processed stage is a final stage for a given partition in the workflow, the executor may transmit the final output to a storage location for results of the workflow. The executor may report the execution status and the location of the final output data to the scheduler or job tracker, ensuring tracking and accessibility for workflow completion or downstream consumption.

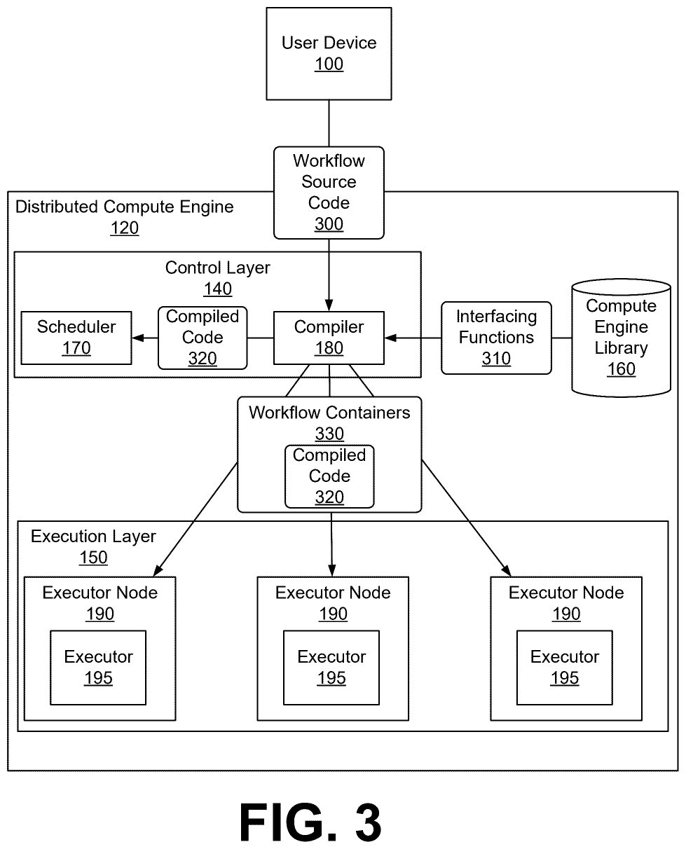

FIG. 3-6 illustrate an example data flow through a distributed compute engine when executing compiled workflow code, in accordance with some embodiments.

FIG. 3 illustrates the distributed compute engine receiving workflow source code 300 from a user device, in accordance with some embodiments. A compiler of the distributed compute engine receives the workflow source code as well as code for interfacing functions 310 from the compute engine library. The compiler generates compiled code 320 based on the workflow source code and the code for the interfacing functions from the compute engine library. The distributed compute engine provides the compiled code to the scheduler 170, which may use the compiled code to schedule the execution of stages within the compiled code at executors at the executor nodes. The distributed compute engine also generates workflow containers 330 based on the compiled code and distributes these containers to executor nodes 190 to initiate executors 195 based on the containers.

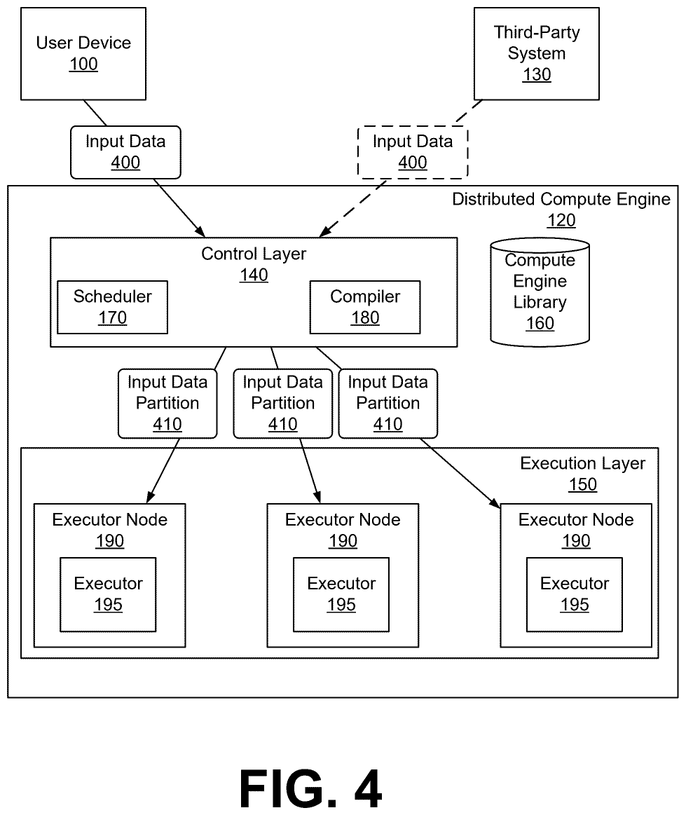

FIG. 4 illustrates the distributed compute system receiving input data 400 from a user device, in accordance with some embodiments. As described above, the distributed compute engine optionally may receive input data 400 from a third-party system instead of or in addition to the user device. The distributed compute engine assigns partitions 410 of the input data to executor nodes for storage when executing the workflow.

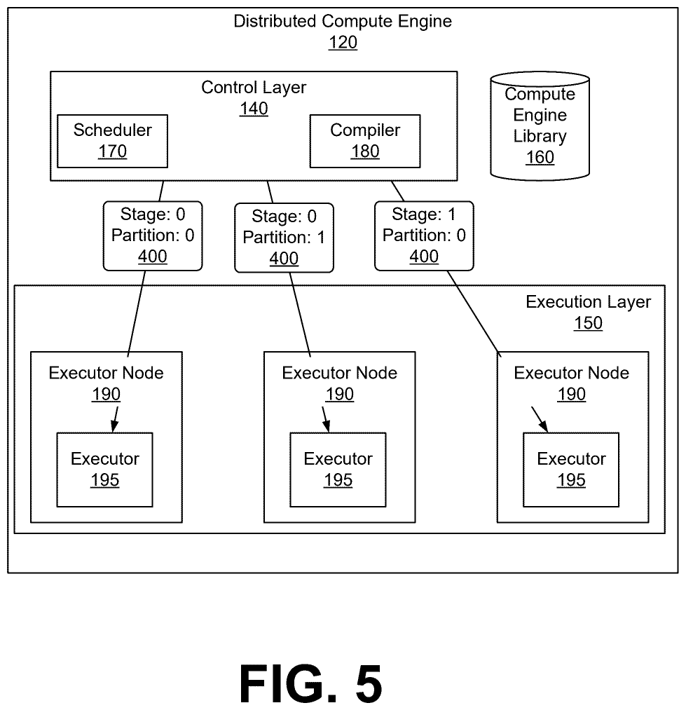

FIG. 5 illustrates the distributed compute engine transmitting instructions 500 to executors, in accordance with some embodiments. The instructions specify which stage of the workflow the executor should execute and which partition the stage should be applied to (e.g., using a stage identifier and a partition identifier, respectively). The executors identify the portion of the compiled source code that corresponds to the identified stage and executes that stage on the identified partition.

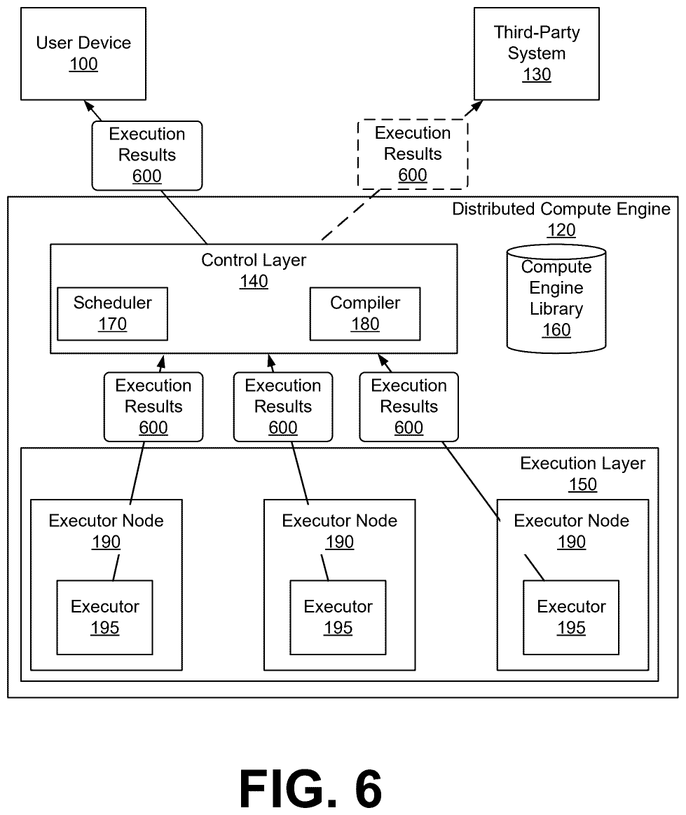

FIG. 6 illustrates the distributed compute engine generating and receiving execution results 600 from executors, in accordance with some embodiments. The distributed compute engine may transmit the generated execution results to a user device or a third-party system. Where the execution results represent intermediate results in the workflow, the distributed compute engine may store the execution results at executor nodes for use in subsequent stages of the workflow.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
storing a library of computer-executable code for interfacing with a distributed compute engine, wherein the computer-executable code comprises functions that are configured to be executed by source code provided by a user device;
receiving workflow source code for a workflow from a user device, wherein the source code comprises a primary set of instructions that define the workflow from a user and an interfacing set of instructions that cause the execution of a subset of the computer-executable code in the library;
identifying the subset of the computer-executable code in the reference library corresponding to the interfacing set of instructions;
generating compiled workflow code based on the received workflow source code and the identified subset of computer-executable code, wherein the compiled workflow code comprises machine code for the workflow source code and machine code for the identified subset of computer-executable code;
initializing a plurality of executors within the distributed compute engine based on the compiled workflow code;
accessing data for inputting to a stage of a plurality of stages of the workflow;
selecting, for one of the executors, a portion of the compiled workflow code for the executor to execute; and
transmitting instructions to the executor to execute the selected portion of the compiled workflow code on a subset of the accessed data.

2. The method of claim 1, wherein generating the compiled workflow code comprises:
statically linking the identified subset of computer-executable code to the workflow source code.

3. The method of claim 1, wherein initializing the plurality of executors comprises:
initializing the plurality of executors on a plurality of executor nodes of the distributed compute engine.

4. The method of claim 3, wherein accessing the data comprises:
storing a subset of the data in each of the plurality of executor nodes.

5. The method of claim 3, wherein initializing an executor of the plurality of executors comprises:
generating a workflow container based on the compiled workflow code, wherein the workflow container comprises the compiled workflow code and dependencies related to the compiled workflow code; and
initializing the executor based on the workflow container.

6. The method of claim 1, wherein the accessed data comprises a plurality of partitions, and wherein the subset of the accessed data is a partition of the plurality of partitions.

7. The method of claim 6, further comprising:
partitioning initial data into the plurality of partitions for the accessed data.

8. The method of claim 6, wherein the transmitted instructions to the executor comprise an identifier for the partition of the plurality of partitions.

9. The method of claim 1, wherein the portion of the compiled workflow code corresponds to a stage of the plurality of stages of the workflow.

10. The method of claim 9, wherein the interfacing set of instructions comprises computer-executable code for designating portions of the primary set of instructions that correspond to each stage of the plurality of stages of the workflow.

11. The method of claim 1, further comprising:
receiving execution results from the executor, wherein the execution results describe an execution of the selected portion of the compiled workflow on the subset of the accessed data.

12. The method of claim 11, further comprising:
responsive to receiving the execution results, selecting a new portion of the compiled workflow code; and
transmitting instructions to the executor to execute the new portion on a new subset of the accessed data.

13. A non-transitory computer readable medium storing computer-executable instructions that, when executed, cause a computer system to perform operations comprising:
storing a library of computer-executable code for interfacing with a distributed compute engine, wherein the computer-executable code comprises functions that are configured to be executed by source code provided by a user device;
receiving workflow source code for a workflow from a user device, wherein the source code comprises a primary set of instructions that define the workflow from a user and an interfacing set of instructions that cause the execution of a subset of the computer-executable code in the library;
identifying the subset of the computer-executable code in the reference library corresponding to the interfacing set of instructions;
generating compiled workflow code based on the received workflow source code and the identified subset of computer-executable code, wherein the compiled workflow code comprises machine code for the workflow source code and machine code for the identified subset of computer-executable code;
initializing a plurality of executors within the distributed compute engine based on the compiled workflow code;
accessing input data for inputting to the workflow;
selecting, for one of the executors, a portion of the compiled workflow code for the executor to execute; and
transmitting instructions to the executor to execute the selected portion of the compiled workflow code on a subset of the accessed input data.

14. The computer-readable medium of claim 13, wherein generating the compiled workflow code comprises:
statically linking the identified subset of computer-executable code to the workflow source code.

15. The computer-readable medium of claim 13, wherein initializing the plurality of executors comprises:
initializing the plurality of executors on a plurality of executor nodes of the distributed compute engine.

16. The computer-readable medium of claim 15, wherein accessing the input data comprises:
storing a subset of the input data in each of the plurality of executor nodes.

17. The computer-readable medium of claim 15, wherein initializing an executor of the plurality of executors comprises:
generating a workflow container based on the compiled workflow code, wherein the workflow container comprise the compiled workflow code and dependencies related to the compiled workflow code; and
initializing the executor based on the workflow container.

18. The computer-readable medium of claim 13, wherein the accessed input data comprise a plurality of partitions, and wherein the subset of the accessed input data is a partition of the plurality of partitions.

19. The computer-readable medium of claim 18, further comprising:
partitioning initial input data into the plurality of partitions for the accessed input data.

20. The computer-readable medium of claim 18, wherein the transmitted instructions to the executor comprise an identifier for the partition of the plurality of partitions.
